(19) United States
(12) Patent Application Publication
(10) Pub. No.: US 2019/0101748 A1
(43) Pub. Date: Apr. 4, 2019

(54) Method for Operating a Pulsed Laser System

(71) Applicant: Dornier MedTech Laser GmbH, Wessling (DE)

(72) Inventors: Werner Hiereth, Gilching (DE); Michael Rampp, München (DE); Alexander Sperl, Berlin (DE)

(21) Appl. No.: 15/724,821

(22) Filed: Oct. 4, 2017

(51) Int. Cl. G02B 27/00; H01S 3/06; H01S 3/091; G02B 6/42; B08B 7/00

(52) U.S. Cl. CPC G02B 27/0006; H01S 3/061; H01S 3/161; G02B 6/4296; B08B 7/0042; H01S 3/0912

(57) ABSTRACT

A method for operating a pulsed laser system includes the steps of pumping a laser resonator of the pulsed laser system by means of a pump source in order to generate operating laser pulses at an operating energy level; and coupling the operating laser pulses with a focusing element into an optical fiber. A step of cleaning the optical fiber by means of cleaning laser pulses is performed prior to generating the operating laser pulses. The laser resonator of the pulsed laser system is pumped by means of the pump source in order to generate the cleaning laser pulses at one or more cleaning energy levels between a laser threshold and the operating energy level.

### TECHNICAL FIELD

The present disclosure relates to a pulsed laser system and a method for operating the pulsed laser system.

### BACKGROUND

Usually, a laser resonator of a pulsed laser system is pumped by means of a pump source in order to generate a laser beam of operating laser pulses at a certain operating energy level. In order to apply the operating laser pulses to a target area, such as inside a human body, the laser beam needs to be coupled into an optical fiber by means of a focusing element and guided via the optical fiber to the target area. For example the focusing element can comprise a coupling lens or a coupling mirror.

However, in order to efficiently couple the laser beam into the optical fiber, a focusing element with high optical quality and a short focal length is needed. Thereby the laser beam is focused on to a small focal point, where a proximal end face of the optical fiber is situated. Consequently, the proximal end face of the optical fiber is in close proximity to the focusing element.

In case the optical fiber is contaminated, e.g. when a reusable optical fiber is not cleaned, disinfected and/or sterilized according to the operating manual, the contaminations on the fiber can absorb the laser beam and get accelerated towards the focusing element whereby it is being sputtered. This dramatically worsens the optical quality and the focusing ability of the focusing element. Thus, the waist of the laser beam increases at the proximal end face of the optical fiber. As soon as the focused laser beam reaches the cladding of the optical fiber, a large amount of energy is dissipated into structures surrounding the proximal end of the optical fiber, such as a buffer or a ferrule. As a consequence, hot glue particles of said structures are sputtered onto the focusing element as well. The described effect leads to a vicious cycle which damages the focusing element so much that it needs to be replaced by a new focusing element which then needs realignment with the laser resonator and the optical fiber.

Document U.S. Pat. No. 9,122,009 B1 discloses fiber optic terminations for discriminating between potentially damaging energy and energy that has potential utility, wherein the potentially damaging energy is dissipated within the fiber optic termination. However, even though the proposed fiber optic terminations increase the lifetime of the optical fiber, they do not prevent the sputtering of the coupling lens when the optical fiber is contaminated.

Document CN 101867142 A discloses a protective lens for a laser coupling mirror of a medical holmium laser treatment machine, which comprises a lens body placed between the coupling mirror and the optical fiber. However, even though this prevents the coupling lens from being sputtered, still the protective lens degrades by being sputtered, which then needs replacement. Moreover, this approach does not prevent the optical fiber from being degraded by the distorted laser beam.

Therefore, a method and a pulsed laser system which provide improved solutions to the degradation of the focusing element and the optical fiber caused by contaminations are desirable.

### SUMMARY

According to an example embodiment of the invention, a method for operating a pulsed laser system is performed where an optical fiber is cleaned prior to generating operating laser pulses by means of cleaning laser pulses, wherein the laser resonator of the pulsed laser system is pumped by means of the pump source in order to generate the cleaning laser pulses at one or more cleaning energy levels between the laser threshold and the operating energy level. Thus, the cleaning laser pulses contain less energy than the operating laser pulses and, therefore, less energy is dissipated as heat in the contaminations or the cladding at the proximal end face of the optical fiber. Consequently, particles still get accelerated away from the proximal end face, however, with less kinetic energy. Thus, the proximal end face of the optical fiber is cleaned by the cleaning laser pulses without sputtering the focusing element.

The pulsed laser system can be a medical pulsed laser system, for example a surgical laser system. Particularly, the pulsed laser system can be a holmium laser system (Ho:YAG-laser).

The pump source can comprise at least one light source such as a pump laser system or a conventional light source. For example, the pump laser system can be a semi conductor laser or the conventional light source can be a flashbulb or an LED. In at least one example the pump source can be configured to generate pump pulses. The pump source can be coupled to the laser resonator by means of a pump energy coupling element, for example a coupling mirror.

The laser resonator can comprise at least two reflecting surfaces and a laser rod, for example a holmium crystal. One of the reflecting surfaces can be configured to be fully-reflecting and the other one of the reflecting surfaces can be configured to be semi-reflecting. The semi-reflecting surface can be an exit surface for the operating laser pulses towards to the focusing element. In at least one example the reflecting surfaces can be embodied as mirrors. In at least one example, the laser resonator can comprise a master resonator with the laser rod and with the at least two reflecting surfaces and an amplification stage with a further laser rod coupled to the master resonator via one of the at least two reflecting surfaces. In this case laser pulses from the master resonator may be amplified by the amplification stage to generate the operating laser pulses and/or the cleaning laser pulses. The pump source may comprise at least one first light source for the master resonator and at least one second light source for the amplification stage. The laser resonator may comprise a Q-switch for controlling the pulse duration of at least one of the operating laser pulses and/or the cleaning laser pulses.

The focusing element can comprise a coupling lens or a coupling mirror. It is also conceivable that the focusing element comprises several optical elements in order to focus the operating laser pulses onto the optical fiber.

The optical fiber can comprise or be any type of waveguide for laser light, such as a glass fiber or a plastic fiber. The optical fiber can be a monomode fiber or a multimode fiber. The optical fiber may comprise a proximal end face for coupling the laser beam of the operating laser pulses and the cleaning laser pulses into the optical fiber. The proximal end face of the optical fiber can be directed to the focusing element and/or a distal end face of the optical fiber can be directed to a target area. Moreover, the optical fiber may comprise a connector element at the proximal end face in order to releasably attach it to a mounting bracket. Thereby, the optical fiber may be easily replaced or removed from the pulsed laser system. The optical fiber can be embodied as a single-use or as a reusable fiber. The distal end face of the optical fiber may be embedded into an operating head which may be used by an operator to irradiate the laser light on to the target area.

“Pumping the laser resonator” can mean in this context to provide energy to the laser resonator causing the laser rod to emit laser light via spontaneous or stimulated emission. In at least one example the laser resonator is provided with light energy during pumping.

“Generating operating laser pulses” can mean to generate a sequence of laser pulses at the operating energy level which is suitable to treat the target area. As an example, the operating energy level can be in a range from 100 mJ to 3000 mJ or in at least one example in a range from 200 mJ to 2000 mJ.

“Cleaning the optical fiber” can mean in this context to remove at least part of a plurality of contaminations from the proximal end face of the optical fiber.

“Laser threshold” can mean that the laser resonator starts emitting laser energy at the lowest possible energy level when it is pumped by the pump source at the laser threshold.

The operating energy level and the clean energy level may refer to a peak energy level of the respective laser pulses.

The one or more cleaning energy levels can be in a range from the laser threshold to below the operating energy level. In at least one example the one or more cleaning energy levels can be in a range from the laser threshold to 10 mJ below the operating energy level.

The pump pulse duration for the cleaning pulses can be at least 600 ps, in at least one example at least 1000 ps. A longer pulse duration of the at least one cleaning laser pulses leads to a lower peak power, whereby the contaminations are accelerated less than with higher peak power.

If the operating energy level is less than a maximum cleaning energy level, then the one or more cleaning energy levels can be in a range from the laser threshold to the operating energy level and if the operating energy level is equal to or above the maximum cleaning energy level, then the one or more cleaning energy levels can be in a range from the laser threshold to the maximum cleaning energy level, wherein the maximum cleaning energy level is in a range from 400 to 1000 mJ. Consequently, if the user sets the operating energy level equal to or above the maximum cleaning energy level, then the cleaning laser pulses are limited to the maximum cleaning energy level for protecting the optical fiber against high energy particles and, furthermore, if the user sets the operating energy level below the maximum cleaning energy level, then the energy of the cleaning laser pulses does not unnecessarily exceed the operating energy level actually used. In at least one example the maximum cleaning energy level can be in a range from 500 mJ to 600 mJ. The maximum cleaning energy level may be an energy level, where the focusing element is not contaminated by accelerated particles from the optical fiber.

If the operating energy level is below the maximum cleaning energy level, the method may comprise a second step of cleaning the optical fiber after generating the first operating laser pulses by means of second cleaning laser pulses, wherein the laser resonator of the pulsed laser system is pumped by means of the pump source in order to generate the second cleaning laser pulses at one or more second cleaning energy levels between the first operating energy level and a second operating energy level, wherein the second operating energy level is higher than the first operating energy level. The method may comprise a step of pumping the laser resonator of the pulsed laser system by means of the pump source after the second step of cleaning the optical fiber in order to generate second operating laser pulses at the second operating energy level. Thus, the optical fiber is not damaged during a second usage at the higher second operating energy level.

The one or more cleaning energy levels can be between the laser threshold and one half or one third of the operating energy level. Thus, the cleaning level is even lower and the risk of the focusing element being sputtered on is further reduced.

The cleaning laser pulses may be generated as a sequence of laser pulse groups, wherein each one of the laser pulse groups comprises at least one of the cleaning laser pulses, and wherein the cleaning energy level is increased from one laser pulse group to a following laser pulse group. By systematically increasing the cleaning energy level from one laser pulse group to the following laser pulse group, the energy to remove and/or vaporize the contaminations is ramped up very smoothly. The lower the energy which is used for different mass of particles, the less energy is deposited in the contamination and the less is the acceleration of the removed/vaporized contamination. Thus, even if a laser pulse group with a high cleaning energy level is coupled into the optical fiber, the contaminations are already removed by a prior laser pulse group with a lower cleaning energy level. Consequently, the risk of the focusing element being sputtered is even further reduced. Each one of the laser pulse groups may comprise only one cleaning laser pulse or a plurality of cleaning laser pulses. If each one of the laser pulse groups comprises a plurality of cleaning laser pulses, the cleaning energy is further distributed in time in order to reduce the risk of the focusing element being sputtered by high-energy particles.

The cleaning energy level may be increased by a linear factor and/or an exponential factor from one laser group to the following laser group. As an example, a pump voltage for driving the pump source may be increased for at least part of the laser pulse groups from one laser pulse group to a following laser pulse group by a constant delta voltage. The constant delta voltage may be in the range of 1V-10V or in at least one example in the range of 2V-5V. As another example, the pump voltage may be increased according to e^{(n/C)}, wherein n is a number of the laser pulse group and C is a constant value. The constant value C may be in the range from 1 to 10 or in at least one example in the range from 3-4.

Each one of the laser pulse groups may comprise at least two of the cleaning laser pulses at the same cleaning energy level. In at least one example each one of the laser pulse groups may include only cleaning laser pulses of the same cleaning energy level. Consequently, the cleaning energy level is increased from one laser pulse group to the following laser pulse group in a step-like manner.

When the optical fiber is a reusable optical fiber, a data storage device associated with it may be readout in order to detect a prior usage of the reusable optical fiber, and wherein the step of cleaning the optical fiber is only carried out, if the prior usage of the reusable optical fiber is detected. Consequently, the reusable optical fiber is not cleaned directly after the production process where it is cleaned anyway. The data storage device may be associated with the connector elements at the proximal end face of the optical fiber. The data storage device may comprise an electronic memory. The method may comprise a step of storing a usage-information-tag into the data storage device after coupling the operating laser pulses with the focusing element into the optical fiber.

The method may further comprise prior to cleaning the optical fiber a step of heating up the laser rod of the pulsed laser system by means of pre-pumping-pulses of the pump source, wherein the pump source is operated below the laser threshold. Thereby, the laser rod is heated up prior to the cleaning step so that it operates at a stable condition.

The pump source may be controlled by a control unit selectively at an operating voltage and/or operating current or at one or more cleaning voltages and/or one or more cleaning currents such that pump energy is provided to the laser resonator selectively at a high level for generating the operating laser pulses at the operating energy level or at one or more low levels for generating the cleaning laser pulses at the one or more cleaning energy levels. In other words the control unit may selectively drive the pump source such that pump energy is provided to the laser resonator selectively at a high level for generating the operating laser pulses at the operating energy level or at one or more low levels for generating the cleaning laser pulses at the one or more cleaning energy levels. Thus, the sequence of the laser pulse groups can be easily implemented by a control function in the control unit. The control unit can be configured to readout the data storage device associated with the reusable optical fiber.

In some example embodiments, the pulsed laser system may include a laser resonator with a laser rod configured to generate operating laser pulses, and a pump source configured to provide pump energy to the laser resonator. The pulsed laser system may further include an optical fiber and a focusing element for coupling the operating laser pulses into the optical fiber. The pulsed laser system may also include a control unit configured to control the pump source at an operating voltage and/or operating current such that the pump energy is provided to the laser resonator at a high level for generating the operating laser pulses at an operating energy level. The control unit may be configured to control the pump source at one or more cleaning voltages and/or one or more cleaning currents such that the pump energy is provided to the laser resonator at one or more low levels for generating cleaning laser pulses at one or more cleaning energy levels between a laser threshold and the operating energy level for cleaning the optical fiber.

According to some example embodiments, the control unit is configured to control the pump source at one or more cleaning voltages and/or one or more cleaning currents such that the pump energy is provided to the laser resonator at one or more low levels for generating cleaning laser pulses at one or more cleaning energy levels between a laser threshold and the operating energy level for cleaning the optical fiber. Thus, the optical fiber is cleaned prior to generating the operating laser pulses by means of the cleaning laser pulses. Since the cleaning laser pulses are generated at one or more cleaning energy levels between a laser threshold and the operating energy level, they contain less energy than the operating laser pulses. Thus, less energy is dissipated as heat in the contaminations or in the cladding of the proximal end face of the optical fiber. Consequently, particles still get accelerated from the proximal end face of the optical fiber, however, with less kinetic energy. Thus, the proximal end face of the optical fiber is cleaned by the cleaning laser pulses without sputtering the focusing element.

The control unit can be configured to perform the method and/or to control the pump source as described herein including the claims. Moreover, the pulsed laser system may comprise the features that are described herein with reference to the method for operating the pulsed laser system, individually or in any combinations.

### BRIEF DESCRIPTION OF THE FIGURES

Further features and advantages of the invention will be explained in greater detail in the following and based on the embodiment shown in the figures. The figures show:

FIG. 1 is a schematic overview of an embodiment of a pulsed laser system;

FIG. 2 is a flow chart of an embodiment of a method for operating the pulsed laser system in FIG. 1; and

FIG. 3 is a diagram showing the energy of the cleaning laser pulses and the operating laser pulses.

### DETAILED DESCRIPTION

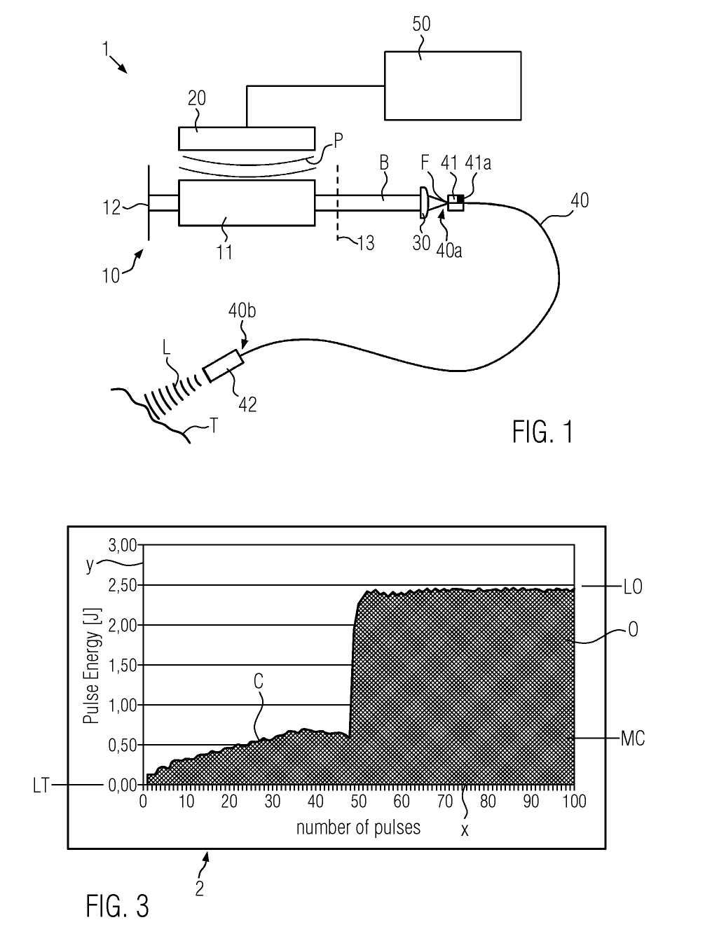

FIG. 1 shows a schematic overview of an embodiment of a pulsed laser system 1. It shows the laser resonator 10 comprising the laser rod 11, the first mirror 12 having a fully reflecting surface and the second mirror 13 having a semi-reflecting surface. The laser rod 11 is for example a holmium crystal (Ho:YAG) which emits infrared light at a wavelength in the range of 2050-2150 nm when resonating. The pump energy P is supplied to the laser rod 11 in a pulsed manner by means of the pump source 20 which may be a flashbulb or a semi conductor laser arrangement. The pump source 20 is controlled by the control unit 50 selectively at an operating voltage or at several cleaning voltages such that pump energy P is provided to the laser rod 11 either at a high level for generating operating laser pulses at an operating energy level or at several low levels for generating cleaning laser pulses at several respective cleaning energy levels. Both the operating voltage and the cleaning voltages are controlled by the control unit 50 to form a pulsed signal at a repetition rate of, for example 20 Hz. Thus, the operating laser pulses and the cleaning laser pulses have said repetition rate. Moreover, the laser resonator 10 may further comprise an amplification stage and a Q-switch.

The operating laser pulses and the cleaning laser pulses are emitted by the laser resonator 10 as the laser beam B which is focused by the focusing element 30 to form the focal point F. In this case the focusing element 30 is a coupling lens. However, it is conceivable that the focusing element 30 may be a coupling mirror or a combination of several optical elements.

Moreover, it can be further seen in FIG. 1 that the proximal end face 40a of the optical fiber 40 is located at the focal point F in order to couple the laser beam B with the operating laser pulses and the cleaning laser pulses into the optical fiber 40. The proximal end face 40a is surrounded by a cladding and embedded in the connector element 41 which is releasably attached to a mounting bracket (not shown). In this case the optical fiber 40 is a reusable fiber which can be used by an operator several times. In order to detect the number of usages, the connector element 41 comprises a data storage device 41a which can be written to and read out by the control unit 50.

The distal end face 40b of the optical fiber 40 is embedded into an operating head 42 which may be used by the operator to irradiate the laser light L on to a target area T.

Since the beam waste needs to be very small at the focal point F in order to provide a high coupling efficiency, the focal distance of the focusing element 30 is as small as possible. Consequently, the proximal end face 40a of the optical fiber 40 is located close to the focusing element 30. Thus, there is a possible risk of contaminations at the proximal end face 40a being heated up by the operating laser pulses and being accelerated towards the focusing element 30. Consequently, the focusing element 30 may become sputtered, if the optical fiber 40 has not been cleaned appropriately.

In order to prevent sputtering of the focusing element 30 the proximal end face 40a of the optical fiber 40 is cleaned by means of cleaning pulses formed according to the method 100 described subsequently.

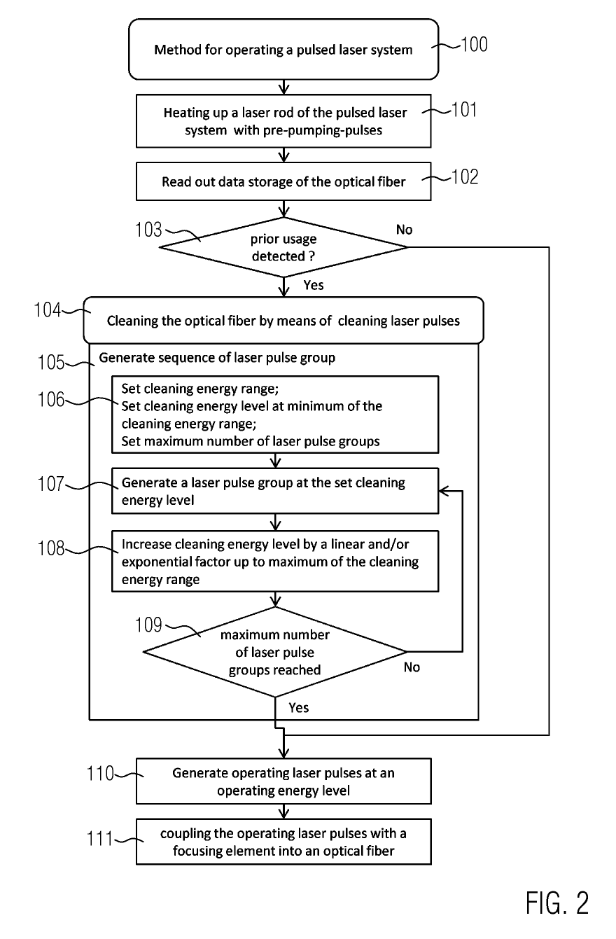

FIG. 2 shows a flow chart of an embodiment of the method 100 for operating the pulsed laser system 1 in FIG. 1.

As a first step 101 the laser rod 11 of the pulsed laser system 1 is heated up with a series of pre-pumping-pulses for stable operation. Therefore, the control unit 50 controls the pump source 20 with a series of pulses at a pre-pulse-voltage below a threshold voltage Uₜₕᵣ which corresponds to the laser threshold. Therefore, the laser rod 11 is heated up without actually generating laser pulses.

As the next step 102 the data storage device 41a of the optical fiber 40 is read out by the control unit 50. If by the decision 103 a prior usage of the optical fiber 40 is not detected, it is new and has been sterilized appropriately after production. Therefore, cleaning is not necessary and the method further proceeds with step 110 as described below. However, if a prior usage of the optical fiber 40 is detected, the cleaning procedure 104 is performed by means of cleaning laser pulses.

In order to minimize the risk of contaminations being sputtered onto the focusing element 30, a sequence of laser pulse groups is generated according to the procedure 105 which is described in conjunction with FIG. 3, which shows as diagram 2 the pulse number on the X-axis and the pulse energy in joules on the Y-axis for the cleaning laser pulses C and the subsequent operating laser pulses P.

As an initial step 106, a cleaning energy range is set. If the operating energy level LO is less than 600 mJ, then the cleaning energy range is set from just below the laser threshold LT to the operating energy level LO. However, if the operating energy level LO is equal to or above 600 mJ, then the cleaning energy range is set from just below the laser threshold LT to 600 mJ. Therefore, the maximum cleaning energy level MC possible is 600 mJ. Moreover, the cleaning laser energy level for the first cleaning laser pulses is set to the minimum of the cleaning energy range. As an example only, the maximum number of laser pulse groups is set to 25, wherein each pulse group has a number of two pulses.

Furthermore, the steps 107-109 are repeated until the maximum number of laser pulse groups is reached: In step 107 a first group of two cleaning laser pulses is generated at a cleaning energy level just below the laser threshold LT. As a next step 108 the cleaning energy level is subsequently increased for the first ten laser pulse groups by a first linear factor and an exponential factor and for the second ten laser pulse groups by a second linear factor, only. The cleaning energy level is increased up until the maximum of the cleaning energy range has been reached, in this case after the second ten laser pulse groups. For the last five laser pulse groups the cleaning energy level is held constant at the maximum of the cleaning energy range. In order to increase the cleaning energy levels, the cleaning voltages U_{FL} applied to the pump source 20 are generated according to formulas (1), (2), wherein n is the index of the laser pulse group and Uₜₕᵣ is the threshold voltage corresponding to the laser threshold:

n∈[1, 10]: U_{FL}(n)=(Uₜₕᵣ−5V)+2.5V*n+e^{n/3.3} (1)

n∈[11, 2]: U_{FL}(n)=U_{FL}(n−1)+4V (2)

In other words the cleaning voltage U_{FL} is increased for the first ten laser pulse groups by the first linear factor 2.5V and the exponential factor e^{n/3.3} and for the second ten laser pulse groups by the second linear factor 4V.

It is understood, that the cleaning voltages U_{FL} represents a peak voltage of a pulsed signal applied to the pump source 20. Within each laser pulse group, the peak voltage of the pulsed signal is constant and, therefore, the cleaning energy level within each laser pulse group is constant for each one of the cleaning laser pulses. For example, the pulsed signal may have a repetition rate of 20 Hz and the pump pulse duration is set to 700 ps.

If the maximum number of laser pulse groups has been reached in step 109, the cleaning procedure is terminated and the operator may begin to generate the operating laser pulses at an operating energy level in step 110. As described above, the operating laser pulses are coupled with the focusing element 30 into the optical fiber 40 in step 110.

As a result, it can be seen in FIG. 3 that during the cleaning procedure 104-109 the laser resonator 10 of the pulsed laser system 1 is pumped by means of the pump source 20 in order to generate the cleaning laser pulses C with increasing cleaning energy levels between the laser threshold LT and the maximum cleaning energy level MC of 600 mJ, wherein the cleaning laser pulses C are generated as a sequence of laser pulse groups. Furthermore, the operating laser pulses O are generated at the operating energy level LO.

Consequently, the optical fiber 40 is cleaned prior to generating the operating laser pulses O by means of cleaning laser pulses C, wherein the laser resonator 10 of the pulsed laser system 1 is pumped by means of the pump source 20 in order to generate the cleaning laser pulses C at cleaning energy levels between the laser threshold LT and the maximum cleaning energy level MC of 600 mJ. Since the cleaning laser pulses C have less energy than the operating laser pulses O, less energy is dissipated as heat in contaminations and the cladding at the proximal end face 40a of the optical fiber 40. Consequently, particles still get removed there from, however, with less kinetic energy. Thus, the proximal end face 40a of the optical fiber 40 is cleaned by the cleaning laser pulses C without sputtering the focusing element 30.

In a further example not shown in FIGS. 1-3, the operating energy level is at 300 mJ below the maximum cleaning energy level of 600 mJ and a second operating energy level at 1000 mJ. Thus, if the optical fiber is only cleaned in steps 106-109 until the operating energy level of 300 mJ, it may become damaged when using it with the second operating energy level of 1000 mJ. Therefore, the method 100 may comprise a second step of cleaning the optical fiber 40 after generating the operating laser pulses 110 by means of second cleaning laser pulses, wherein the laser resonator 10 of the pulsed laser system 1 is pumped by means of the pump source 20 in order to generate the second cleaning laser pulses at second cleaning energy levels between the operating energy level of 300 mJ and a second operating energy level of 1000 mJ. Specifically, as the maximum cleaning energy level MC is still 600 mJ, the second cleaning laser pulses are generated between the operating energy level of 300 mJ and 600 mJ.

Afterwards, the laser resonator 10 is pumped by means of the pump source 20 after the second step of cleaning the optical fiber 40 in order to generate second operating laser pulses at the second operating energy level of 1000 mJ.

It is understood that features mentioned in the previously described embodiments are not limited to these combinations but are also possible individually or in any other combinations.

What is claimed is:

1. A method for operating a pulsed laser system, the method comprising the steps of:
pumping a laser resonator of the pulsed laser system by means of a pump source in order to generate operating laser pulses at an operating energy level; and
coupling the operating laser pulses with a focusing element into the optical fiber, wherein a step of cleaning the optical fiber by means of cleaning laser pulses is performed prior to generating the operating laser pulses, wherein the laser resonator of the pulsed laser system is pumped by means of the pump source in order to generate the cleaning laser pulses at one or more cleaning energy levels between a laser threshold and the operating energy level.

2. The method according to claim 1, wherein if the operating energy level is less than a maximum cleaning energy level, then the one or more cleaning energy levels is in a range from the laser threshold to the operating energy level and if the operating energy level is equal to or above the maximum cleaning energy level, then the one or more cleaning energy levels is in a range from the laser threshold to the maximum cleaning energy level, wherein the maximum cleaning energy level is in a range from 400 to 1000 mJ.

3. The method according to claim 2, wherein if the operating energy level is below the maximum cleaning energy level, the method comprises a second step of cleaning the optical fiber after generating the operating laser pulses by means of second cleaning laser pulses, wherein the laser resonator of the pulsed laser system is pumped by means of the pump source in order to generate the second cleaning laser pulses at one or more second cleaning energy levels between the operating energy level and a second operating energy level, wherein the second operating energy level is higher than the operating energy level.

4. The method according to claim 1, wherein the cleaning laser pulses are generated as a sequence of laser pulse groups, wherein each one of the laser pulse groups comprises at least one of the cleaning laser pulses, and wherein the one or more cleaning energy levels are increased from one laser pulse group to a following laser pulse group.

5. The method according to claim 4, wherein the one or more cleaning energy level are increased by a linear factor and/or an exponential factor from the one laser pulse group to the following laser pulse group.

6. The method according to claim 4, wherein each one of the laser pulse groups comprises at least two of the cleaning laser pulses at the same cleaning energy level.

7. The method according to claim 1, wherein the optical fiber is a reusable optical fiber.

8. The method according to claim 7, wherein a data storage device associated with the reusable optical fiber is readout in order to detect a prior usage of the reusable optical fiber, and wherein the step of cleaning the optical fiber is only carried out, if the prior usage of the reusable optical fiber is detected.

9. The method according to claim 1, wherein the method further comprises, prior to cleaning the optical fiber, a step of heating up a laser rod of the pulsed laser system by means of pre-pumping-pulses of the pump source, wherein the pump source is operated below the laser threshold.

10. The method according to claim 1, wherein the pump source is controlled by a control unit selectively at an operating voltage and/or operating current or at one or more cleaning voltages and/or one or more cleaning currents such that pump energy is provided to the laser resonator selectively at a high level for generating the operating laser pulses at the operating energy level or at one or more low levels for generating the cleaning laser pulses at the one or more cleaning energy levels.

11. A pulsed laser system, comprising:
a laser resonator with a laser rod configured to generate operating laser pulses;
a pump source configured to provide pump energy (P) to the laser resonator;
an optical fiber;
a focusing element for coupling the operating laser pulses into the optical fiber; and
a control unit configured to control the pump source at an operating voltage and/or operating current such that the pump energy is provided to the laser resonator at a high level for generating the operating laser pulses at an operating energy level, wherein the control unit is configured to control the pump source at one or more cleaning voltages and/or one or more cleaning currents such that the pump energy is provided to the laser resonator at one or more low levels for generating cleaning laser pulses at one or more cleaning energy levels between a laser threshold and the operating energy level for cleaning the optical fiber.

12. The system according to claim 11, wherein if the operating energy level is less than a maximum cleaning energy level, then the one or more cleaning energy levels is in a range from the laser threshold to the operating energy level and if the operating energy level is equal to or above the maximum cleaning energy level, then the one or more cleaning energy levels is in a range from the laser threshold to the maximum cleaning energy level, wherein the maximum cleaning energy level is in a range from 400 to 1000 mJ.

13. The system according to claim 12, wherein the laser resonator of the pulsed laser system is pumped by means of the pump source in order to generate second cleaning laser pulses at one or more second cleaning energy levels between the operating energy level and a second operating energy level, wherein the second operating energy level is higher than the operating energy level.

14. The system according to claim 11, wherein the cleaning laser pulses are generated as a sequence of laser pulse groups, wherein each one of the laser pulse groups comprises at least one of the cleaning laser pulses, and wherein the one or more cleaning energy levels are increased from one laser pulse group to a following laser pulse group.

15. The system according to claim 14, wherein the one or more cleaning energy levels are increased by a linear factor and/or an exponential factor from the one laser pulse group to the following laser pulse group.

16. The system according to claim 14, wherein each one of the laser pulse groups comprises at least two of the cleaning laser pulses at the same cleaning energy level.

17. The system according to claim 11, wherein the optical fiber is a reusable optical fiber.

18. The system according to claim 17, wherein a data storage device associated with the reusable optical fiber is configured to be readout in order to detect a prior usage of the reusable optical fiber.

19. The system according to claim 11, wherein the pump source is configured to provide pre-pumping-pulses for heating up a laser rod of the pulsed laser system, wherein the pump source is operated below the laser threshold.
